(19) United States
(12) Patent Application Publication
(10) Pub. No.: US 2017/0019730 A1
(43) Pub. Date: Jan. 19, 2017

(54) HEADSET MOUNTABLE MICROPHONE SHIELD

(71) Applicant: Alex Pruitt, Bessemer, AL (US)

(72) Inventor: Alex Pruitt, Bessemer, AL (US)

(21) Appl. No.: 14/803,083

(22) Filed: Jul. 19, 2015

(51) Int. Cl. H04R 1/10

(52) U.S. Cl. CPC H04R 1/1091

(57) ABSTRACT

A headset mountable microphone shield for obscuring the lips of a wearer of a conventional headset with hands free microphone. The headset mountable microphone shield includes a shield body which defines a planar member sized to obscure the mouth of a person and which is integrated with a clip member which defines an elongated limb with a front side and a back side. The clip member is attachable to a stem which connects a hands free microphone to a conventional headset through a pair of clips on its back side and secured in place with fastening screws which operate in conjunction with the clips. As such, a user can slide the stem into the clips and tighten the fastening screws, thereby wedging the stem against the clip such that it is held in place.

### BACKGROUND OF THE INVENTION

Field of the Invention

This invention relates generally to mouth shielding devices and, more particularly, to a headset attachable microphone shielding apparatus for obscuring the mouth of a user of a microphone.

Description of the Prior Art

The use of hands free microphones, typically mounted on a stem which extends from a headset to an area in front a wearer's mount, by football coaches and other sports participants/administrators is well known. A problem which still exists, however, is that it is common for opposing coaches or players, or those working with the opposing team, to attempt to intercept communications which are spoken into such a conventional hands free microphone by reading the speaker's lips. To combat this problem, football coaches or other speakers commonly hold a board or sheet, such as a play sheet, up to their mouth when speaking into the microphone to obscure their mouth. Such a manual system, however, is not always effective because not only does it result in the speaker showcasing that fact he is about to speak before he does it, the speaker may not always fully cover his mouth. Thus, there remains a need for a headset mountable microphone shield which would eliminate the need for a user of a hands free microphone to manually cover their mouth each time they were going to speak into the microphone. It would be helpful if such a headset mountable microphone shield clipped directly on the stem which connects the microphone to a headset. It would be additionally desirable for such a headset mountable microphone shield to employ an attachment system which enabled it to be selectively fixed in place once clipped on the stem.

The Applicant's invention described herein provides for a headset mountable microphone shield adapted to attach to the stem which connects a hands free microphone to a headset. The primary components in Applicant's headset mountable microphone shield are a shield body, a clip member, and a fastening screw. When in operation, the headset mountable microphone shield enables a speaker to have their mouth completely shielded at all times while speaking into a hands free microphone. As a result, many of the limitations imposed by prior art structures are removed.

### SUMMARY OF THE INVENTION

A headset mountable microphone shield for obscuring the lips of a wearer of a conventional headset with hands free microphone. The headset mountable microphone shield includes a shield body which defines a planar member sized to obscure the mouth of a person and which is integrated with a clip member which defines an elongated limb with a front side and a back side. The clip member is attachable to a stem which connects a hands free microphone to a conventional headset through a pair of clips on its back side and secured in place with fastening screws which operate in conjunction with the clips. As such, a user can slide the stem into the clips and tighten the fastening screws, thereby wedging the stem against the clip such that it is held in place and will not slide or rotate.

It is an object of this invention to provide a headset mountable microphone shield which eliminates the need for a user of a hands free microphone to manually cover their mouth each time they were going to speak into the microphone.

It is another object of this invention to provide a headset mountable microphone shield that clips directly on the stem which connects the microphone to a headset.

It is yet another object of this invention to provide a headset mountable microphone shield that employs an attachment system defined by a clip and fastening screw which enables it to be selectively fixed in place once clipped on the stem.

These and other objects will be apparent to one of skill in the art.

### BRIEF DESCRIPTION OF THE DRAWINGS

FIG. 1 is a front elevational view of a conventional headset with hands free microphone.

FIG. 2 is a front elevational view of a headset mountable microphone shield built in accordance with the present invention.

FIG. 3a is a side elevational view of a headset mountable microphone shield built in accordance with the present invention with a fastening screw in a secured position.

FIG. 3b is a side elevational view of a headset mountable microphone shield built in accordance with the present invention with a fastening screw in an open position.

FIG. 4 is a partial back elevational view of a clip of a headset mountable microphone shield built in accordance with the present invention.

FIG. 5 is a front elevational view of a headset mountable microphone shield built in accordance with an alternate embodiment of the present invention.

### DETAILED DESCRIPTION OF THE INVENTION

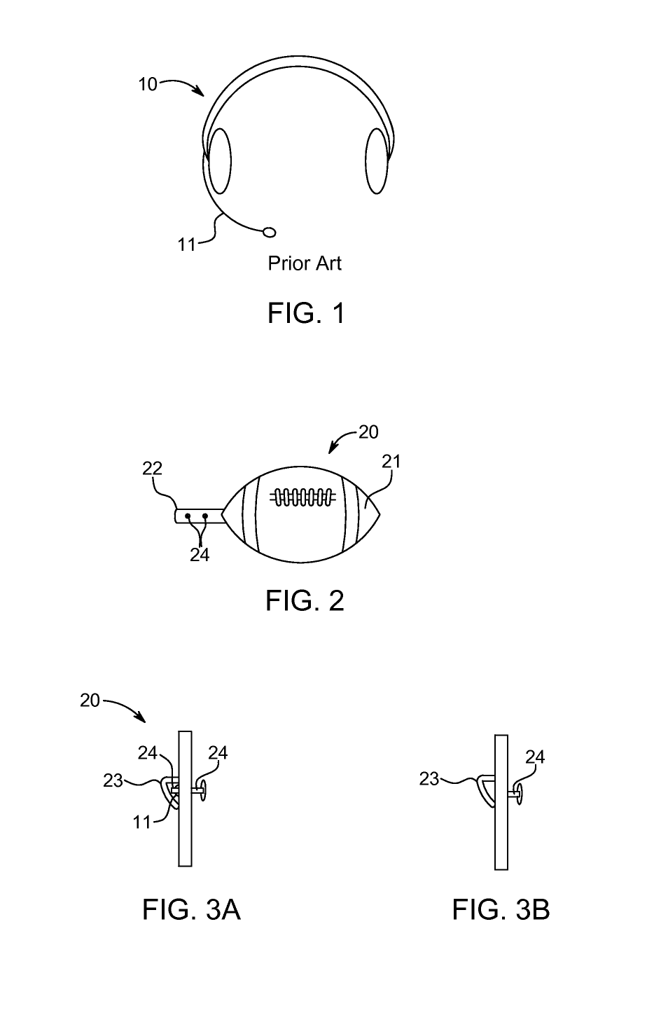

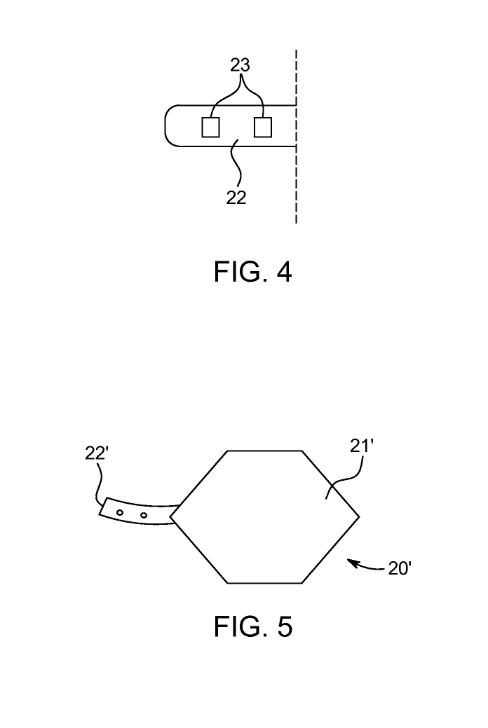

Referring now to the drawings and in particular FIGS. 1, 2, 3a, 3b, and 4, a headset mountable microphone shield 20 is shown as a shield body 21 integrated with a clip member 22. The shield body 21 defines a planar member sized such that when it is placed in front of the mouth of a person, it fully shields the lips of the mouth, whether open or closed, from substantially any angle from which the movement of the lips could be deciphered into language or otherwise read. In the preferred embodiment, the shield body 21 measures at least six (6) inches wide and four (4) inches tall.

Connected to one end of the shield body 21 is the clip member 22. The clip member 22 defines an elongated limb with a front side and a back side and which extends from the shield body 21. The clip member 22 is attachable to a stem 11 which connects a hands free microphone to a conventional headset 10. In the illustrated embodiment, the clip member 22 defines a straight planar limb.

The back side of the clip member 22 includes two biased clips 23 into which the stem 11 can be slid. A fastening screw 24 is employed with each clip 23 to the stem 11 in place inside the clip 23. The screw 24 can be engaged so that it passes through the clip member 22, and as it passes through the clip member 22, it moves closer and closer to the clip 23. In this manner, the stem 11 which has been slid into the clip 23 can be wedged against the clip 23 by the fastening screw 24, as illustrated in FIG. 3a.

When it is desired to remove the stem 11, the fastening screw 24 is loosened so that it receeds back into and through the clip member 22, as illustrated in FIG. 3b, and the stem 11 can be slid down out of the clips 23.

Referring now to FIG. 5, in an alternate embodiment of the headset mountable microphone shield 20′, the shield body 21′ defines an alternate shape and the clip member 22′ is curved such that it contours to the shape of conventional headset microphone stems.

The instant invention has been shown and described herein in what is considered to be the most practical and preferred embodiment. It is recognized, however, that departures may be made therefrom within the scope of the invention and that obvious modifications will occur to a person skilled in the art.

1. A headset mountable microphone shield, comprising:
a shield body defining a planar member sized to shield a mouth of a person when positioned in front thereof;
a clip member integral with said shield body and adapted to attach to a stem which connects a hands free microphone to a conventional headset; and
at least one clip integral with said clip member and configured to enable then stem to engagably slide therein.

2. The headset mountable microphone shield of claim 1, additionally comprising an elongated fastener associated with each of the at least one clips, wherein each of said elongated fasteners is configured to selectively wedge a stem slidably engaged in the fastener's respective clip against the clip, thereby fixing the stem in place in the clip.

3. The headset mountable microphone shield of claim 1, wherein said clip member defines an elongated limb which extends from the shield body.

4. The headset mountable microphone shield of claim 3, wherein said clip member and said shield body are oriented on a single plane.

5. The headset mountable microphone shield of claim 3, wherein said clip member defines a straight planar limb.

6. The headset mountable microphone shield of claim 3, wherein said clip member defines a curved limb.

7. The headset mountable microphone shield of claim 1, wherein said clip member includes two clips.

8. A headset mountable microphone shield, comprising:
a shield body defining a planar member sized to shield a mouth of a person when positioned in front thereof;
a clip member integral with said shield body and adapted to attach to a stem which connects a hands free microphone to a conventional headset;
a plurality of clips integral with said clip member and configured to enable then stem to engagably slide therein; and
an elongated fastener associated with each of the at least one clips, wherein each of said elongated fasteners is configured to selectively wedge a stem slidably engaged in the fastener's respective clip against the clip, thereby fixing the stem in place in the clip.

9. The headset mountable microphone shield of claim 8, wherein said clip member defines an elongated limb which extends from the shield body.

10. The headset mountable microphone shield of claim 9, wherein said clip member and said shield body are oriented on a single plane.

11. The headset mountable microphone shield of claim 9, wherein said clip member defines a straight planar limb.

12. The headset mountable microphone shield of claim 9, wherein said clip member defines a curved limb.
